(19) United States
(12) Patent Application Publication
(10) Pub. No.: US 2014/0072672 A1
(43) Pub. Date: Mar. 13, 2014

(54) HYDROCOLLOID STABILIZED DEHYDRATED FOOD FOAM

(71) Applicant: CORNELL UNIVERSITY, Ithaca, NY (US)

(72) Inventors: Mark Nisbet, Ithaca, NY (US); David Cullinan, McKinney, TX (US); Claire Aucella, Severn, MD (US); Lena Halabi, Minneapolis, MN (US); Dongjun Zhao, Ithaca, NY (US); Meagan M. McKeever, Mechanicville, NY (US)

(73) Assignee: CORNELL UNIVERSITY, Ithaca, NY (US)

(21) Appl. No.: 13/985,161

(22) PCT Filed: Feb. 15, 2012
(86) PCT No.: PCT/US2012/025276

§ 371 Date: Nov. 26, 2013

Related U.S. Application Data
(60) Provisional application No. 61/442,894, filed on Feb. 15, 2011.

(51) Int. Cl. A23L 1/00

(52) U.S. Cl. CPC A23L 1/0097
USPC 426/72; 426/564; 426/541; 426/569; 426/557; 426/112

(57) ABSTRACT

The present invention relates to a dehydrated and aerated food product. The dehydrated and aerated food product includes a plant puree mixture and a hydrocolloid. The plant puree mixture and hydrocolloid combine to form a dehydrated and aerated plant puree foam having a hydrocolloid-based aeration network dispersed throughout the plant puree mixture. The present invention also relates to methods of making and using the dehydrated and aerated food product, and combination food products that include the dehydrated and aerated food product.

### CROSS-REFERENCE TO RELATED APPLICATIONS

This application claims priority benefit of U.S. Provisional Patent Application Ser. No. 61/442,894, filed Feb. 15, 2011, the disclosure of which is hereby incorporated by reference herein in its entirety.

### FIELD OF THE INVENTION

The present invention relates to, inter alia, a dehydrated and aerated food product, methods of making and using the dehydrated and aerated food product, and combination food products that include the dehydrated and aerated food product.

### BACKGROUND OF THE INVENTION

Dehydration, such as freeze-drying or vacuum oven drying, has been used to preserve plant based material, such as fruits and vegetables, as well as meats, for use in food products. Examples of such food products include dried fruit slices, freeze dried corn, dried soup mixes, and jerkies. While juices and purees can also be freeze-dried, the process breaks down bonds that hold the food stuff together, resulting in the juice and puree forming a powder.

Several vegetable-based chips or treats currently on the market are designed to have vegetable-like colors or shapes. However, these snacks are starch-based or high in fat content due to frying, drying, or coating with oil and seasonings. Further, they require artificial coloring to approximate the natural coloration of the source vegetables.

US-2011/0008515-A1 describes freeze-dried, aerated fruit or vegetable compositions and methods of making these compositions. The composition includes a fruit or vegetable ingredient, an emulsifier (particularly lactylated mono- and diglycerides), and a viscosity enhancer. Further, the composition is required to be pasteurized. In addition, the method for making the composition requires the steps of: (i) providing a fruit or vegetable blend; (ii) adding an emulsifier; (iii) thermally processing the fruit or vegetable blend; (iv) fermenting the blend; (v) admixing a gas with the blend; (vi) simultaneously aerating the gas and the fruit or vegetable blend to form an aerated product; (vii) cooling the product (optional step); and (viii) freeze-drying the product. However, there is no support to show that this method is effective to preserve the natural coloration or nutritive qualities of the source fruit or vegetable materials. Further, this method involves heating and requires particular emulsifiers.

There is a need for a food foam product made from fruits and/or vegetables that maintains its natural coloration and nutritive qualities, as well as a method of making the food foam in a way that preserves the natural coloration and nutritive qualities of the source fruits and/or vegetables.

The present invention is directed to overcoming these and other deficiencies in the art.

### SUMMARY OF THE INVENTION

In one aspect, the present invention relates to a dehydrated and aerated food product. The dehydrated and aerated food product includes a plant puree mixture and a hydrocolloid. The plant puree mixture and hydrocolloid combine to form a dehydrated and aerated plant puree foam having a hydrocolloid-based aeration network dispersed throughout the plant puree mixture.

In another aspect, the present invention relates to a method of making a plant puree food product. The method involves combining a plant puree mixture with a hydrocolloid under conditions effective to disperse the hydrocolloid throughout the plant puree mixture. The plant puree mixture/hydrocolloid combination is then aerated under conditions effective to yield a stable aerated plant puree foam. The aerated plant puree foam is then dehydrated using a non-heat-based dehydration process to yield the plant puree food product. The plant puree food product produced by this method includes a dehydrated and aerated plant puree foam having a hydrocolloid-based aeration network dispersed throughout the plant puree mixture.

In one embodiment, the method of the present invention further includes the step of forming the aerated plant puree foam into a desired shape, thereby yielding a plant puree food product having the desired shape. This step is performed prior to the dehydrating step of the method of the present invention.

In another embodiment, the method of the present invention further includes the step of adding at least one food additive prior to the aerating step of the method of the present invention.

In another aspect, the present invention relates to a plant puree food product produced according to the method of the present invention.

In a further aspect, the present invention relates to a combination food product that includes a dehydrated and aerated food product according to the present invention combined with another edible foodstuff.

One advantage of the present invention over the existing art is that it uses a food-based puree as a starting ingredient in a way that provides an opportunity to shorten dehydration time, such as freeze drying, as there is more surface area per volume and more open pores than a whole food piece. As noted herein, the food puree may be derived from vegetable plants and fruit plants, including any of the parts of the plants. The food puree may also be derived from meats or dairy sources. Therefore, even though the present disclosure describes plant purees, the present invention also contemplates that meats and dairy sources can be used in place of or in addition to plant sources in providing the puree starting material.

Another advantage of the present invention over the existing art is the use of the hydrocolloid as a stabilizing agent to form a binding that is capable of holding the foamed food puree into a stable food product with a distinct shape and preventing the foamed food puree from turning into a powder.

The food product and method of making the food product of the present invention have unique features over the existing art. As described herein, in certain embodiments the food product of the present invention includes hydrocolloids (e.g., proteins, gums, starches), puree (e.g., fruit, vegetable, meat, dairy products), colors (optional), and flavors (optional). The components are combined in such a way to create an aerated foam. This foam is then dehydrated (e.g., freeze-dried) to stabilize it. The puree/foaming process results in more efficient drying compared to whole fruit and vegetable pieces due to decreased product density and liberation of tightly bound water within the fruit or vegetable or other source (e.g., meat, dairy). Using food puree is generally lower cost than using whole foods such as whole vegetables or fruits. By altering the moisture, type, and level of hydrocolloid, the texture can vary from crunchy to spongy. The present invention also provides the ability to optionally incorporate flavors and/or colors in the puree. The present invention further provides the ability to combine varieties of fruits, vegetables, meats, and dairy into one product. The present invention also provides the ability to freeze-dry the puree into various shapes. Further, the incorporation of hydrocolloids reduces the friability of the dried pieces resulting in a more stable product with less crumbs and broken pieces.

The present invention is useful for a variety of purposes. For example, the food product of the present invention can be used as a fruit- or vegetable-based snack food. Further, the present invention allows for the creation of stable, nutritious meal replacements made from pureed meal components. The food product of the present invention also can be used to stabilize sauces and soups that can be reconstituted with hot water or cold water.

In addition to being used as a food snack for humans, the dehydrated and aerated food product of the present invention can be formulated as a food for animals such as pets (e.g., dogs and cats) and farm and other domestic animals (e.g., cattle, horses, pigs, sheep). In some instances, the dehydrated and aerated food product of the present invention can be packaged as a trail mix that can be consumed by both humans and pets (e.g., dogs).

These and other objects, features, and advantages of this invention will become apparent from the following detailed description of the various aspects of the invention taken in conjunction with the accompanying drawings.

### BRIEF DESCRIPTION OF THE DRAWINGS

For the purpose of illustrating aspects of the present invention, there are depicted in the drawings certain embodiments of the invention. However, the invention is not limited to the precise arrangements and instrumentalities of the embodiments depicted in the drawings. Further, as provided, like reference numerals contained in the drawings are meant to identify similar or identical elements.

The patent or application file contains at least one drawing executed in color. Copies of this patent or patent application publication with color drawing(s) will be provided by the Office upon request and payment of the necessary fee.

FIGS. 1A and 1B are process flow schematic drawings of various embodiments of a method of making a dehydrated and aerated food product of the present invention.

FIG. 2 is a photograph of a one embodiment of a dehydrated and aerated food product of the present invention. The source material for this embodiment is carrot puree. The food foam product was created using vegetable puree mixed with hydrocolloid, sheeted, cut into squares, and freeze dried.

FIG. 3 is a photograph of various embodiments of different dehydrated and aerated food products of the present invention. The source materials for these embodiments are carrot puree (orange), broccoli puree (green), and tomato puree (red). The food foam products were created using vegetable puree mixed with hydrocolloid, sheeted, cut into squares, and freeze dried.

FIG. 4 is a drawing that shows the source materials (broccoli, carrots, and tomato) that are used to make the corresponding dehydrated and aerated food products of the present invention. Arrows are used to identify the source material for each corresponding food product of the present invention.

FIG. 5 is a drawing that shows the source materials (broccoli, carrots, and tomato) that are used to make the corresponding dehydrated and aerated food products of the present invention, as well as suitable packaging for the food products.

FIG. 6 is a photograph showing a dehydrated and aerated food product of the present invention before and after being reconstituted in cold water. The source material for this embodiment is carrot puree.

FIG. 7 is a photograph showing a dehydrated and aerated food product of the present invention before and after being reconstituted in hot water. The source material for this embodiment is carrot puree.

FIG. 8 is a photograph showing freeze-dried fresh carrots (top panel) and dehydrated and aerated food products of the present invention made of a carrot puree (bottom panel).

### DETAILED DESCRIPTION OF THE INVENTION

The present invention relates to a new hydrocolloid stabilized dehydrated food foam that combines a plant puree mixture with a hydrocolloid. As described herein, the hydrocolloid stabilized dehydrated food foam of the present invention provides a number of advantages over existing food foams, including, without limitation, the preservation of natural coloration and nutritive qualities of the source fruit or vegetable used to make the plant puree mixture. The hydrocolloid stabilized dehydrated food foam also is less friable and more stable than existing food foams. Further, the hydrocolloid stabilized dehydrated food foam of the present invention does not require preservatives or artificial coloring. In addition, the shelf-life of the hydrocolloid stabilized food foam of the present invention is suitable for long-term storage (e.g., at least two years), depending on the packaging thereof. Due to its long shelf-life and dehydrated form, the hydrocolloid stabilized food foam can be used as a source of nutrition in everyday situations (e.g., a daily snack), recreational situations (e.g., camping), and more long-term situations (e.g., as a survival food, and as a source of food during natural disasters or other emergency situations). Therefore, the hydrocolloid stabilized dehydrated food foam of the present invention can be used in a wide variety of ways, including, for example, as a healthful snack and means to provide a natural source of vegetables or fruits in combination foods. The present invention also relates to methods of making and using the hydrocolloid stabilized dehydrated food foam of the present invention, as well as combination foods containing the hydrocolloid stabilized dehydrated food foam of the present invention.

As used herein, the term “hydrocolloid stabilized dehydrated food foam” is also referred to herein as a “dehydrated and aerated food product” and as a “plant puree food product” (particularly when referred to as a product of the method of the present invention).

In one aspect, the present invention relates to a dehydrated and aerated food product. The dehydrated and aerated food product includes a plant puree mixture and a hydrocolloid. The plant puree mixture and hydrocolloid combine to form a dehydrated and aerated plant puree foam having a hydrocolloid-based aeration network dispersed throughout the plant puree mixture.

One advancement of the dehydrated and aerated food product of the present invention over the existing food foams is that the plant puree mixture and hydrocolloid combination are not subject to heat-based dehydration when combined to form the dehydrated and aerated plant puree foam.

Prior to dehydration, the combination of the plant puree mixture and the hydrocolloid has a number of measurable attributes, including nutritive attributes, aesthetic attributes (e.g., coloration), textural attributes, and the like.

Viscosity is just one example of such a measurable attribute. Viscosity can be measured using methods and instruments well known in the art, including, for example, using a Brookfield Viscometer and a Helipath stand along with standard protocols. In accordance with the present invention, the combination of the plant puree mixture and the hydrocolloid prior to dehydration can have a viscosity ranging from about 1,000 to about 700,000 centipoise (cP). The viscosity can be measured at various timeframes after aeration. Although upper and lower limits are provided for the viscosity of the plant puree mixture and hydrocolloid combination prior to dehydration, the viscosity of this combination prior to dehydration is not limited to those upper and lower limits but also includes all viscosity values falling within those upper and lower limits.

As set forth herein, certain of these attributes of the plant puree mixture can be maintained (e.g., preserved or retained) even after dehydration, which is an inventive advancement over the existing food foams.

As used herein, the term “plant puree mixture” refers to a vegetable puree, a fruit puree, or a mixture thereof. The present invention is not limited to particular vegetable or fruit sources and, therefore, contemplates the use of any vegetable or fruit as the raw material for the vegetable puree, fruit puree, or mixture thereof.

For illustrative purposes only, and without meaning to be limited thereto, suitable vegetables that can be used as a source for the vegetable puree of the present invention can include, without limitation, carrot, peppers (e.g., green peppers, red peppers, etc.), beets, beans (e.g., green beans, lima beans, etc.), peas, potato, sweet potato, broccoli, tomato (also referred to herein as a fruit), celery, spinach, zucchini, cucumber, cauliflower, onion, scallion, asparagus, garlic, corn, etc.

For illustrative purposes only, and without meaning to be limited thereto, suitable fruits that can be used as a source for the fruit puree of the present invention can include, without limitation, strawberry, melons (e.g., watermelon, honeydew melon, cantaloupe, etc.), blackberry, blueberry, cherry, apple, banana, raspberry, mango, papaya, orange, pear, tangerine, tomato (also referred to herein as a vegetable), cranberry, nectarine, kiwi, lemon, grapefruit, grape, plum, etc.

As indicated herein above, a plant puree mixture also refers to a mixture of two or more different fruits with one another, a mixture of two or more different vegetables with one another, or a mixture of two or more different fruits and different vegetables with one another. Therefore, any combination of fruits with fruits, vegetables with vegetables, and fruits with vegetables is contemplated by the term “plant puree mixture.” As discussed herein, in some embodiments, meat and/or dairy sources can also be used in place of or in addition to the plant puree mixture. Those of ordinary skill in the art are well aware of how to produce or provide a plant puree mixture according to the present invention.

The plant puree mixture can be pretreated in accordance with sanitary practices. Such pretreatment can include pasteurization or other forms of sterilization against microorganisms or other unwanted food contaminants. The plant puree mixture can be provided by a commercial vendor or can be prepared by the user.

The plant puree mixture can be made from any portion of the source vegetable plant or fruit plant. Such portions of source plant can include, without limitation, leaves, stems, stalks, fruit tissue, seeds, roots, flowers, flower buds, etc. Further, the plant puree mixture can be made from particular categories of plant portions, such as root portions (e.g., carrots, beets, etc.), leaf/stalk portions (e.g., broccoli florets, spinach leaves, celery stalks), and fruit portions (e.g., tomato fruit, strawberry fruit, orange fruit). The plant puree mixture can also be produced from vegetables and processing byproducts, including, for example, plant waste produced during baby carrot production.

In one embodiment, the plant puree mixture is present in the dehydrated and aerated food product in an amount ranging from about 10 percent by weight to about 95 percent by weight based on total dry weight. Although a beginning and ending percent by weight is provided for the plant puree mixture, the present invention is not limited to those upper and lower limits but also includes all percentages by weight falling within those upper and lower limits.

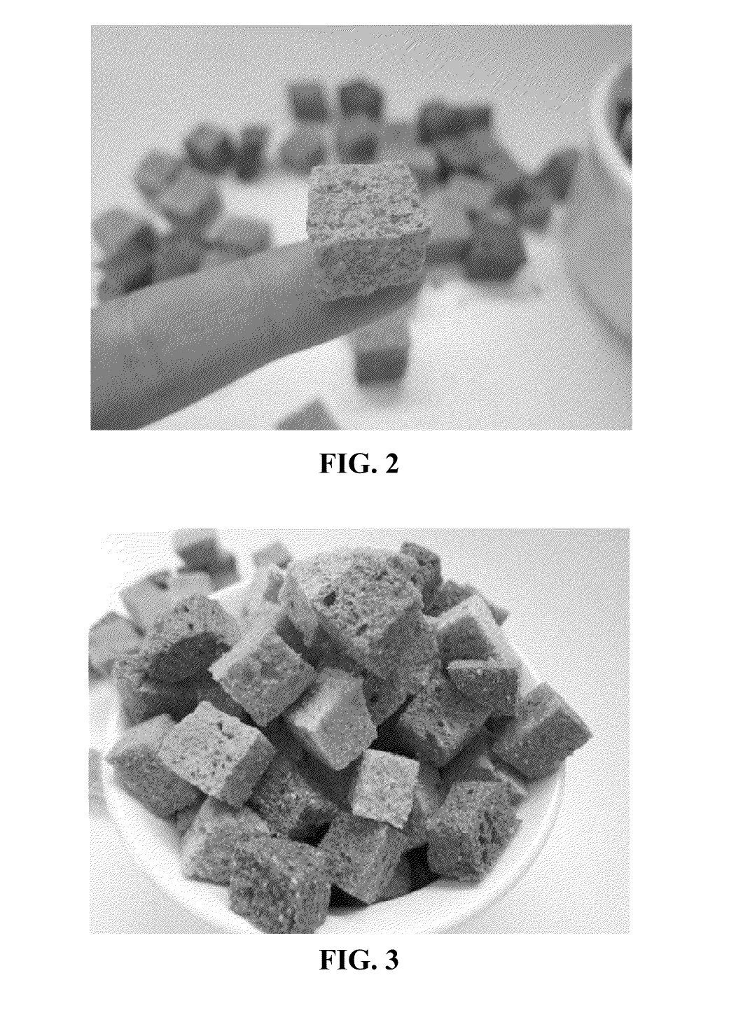

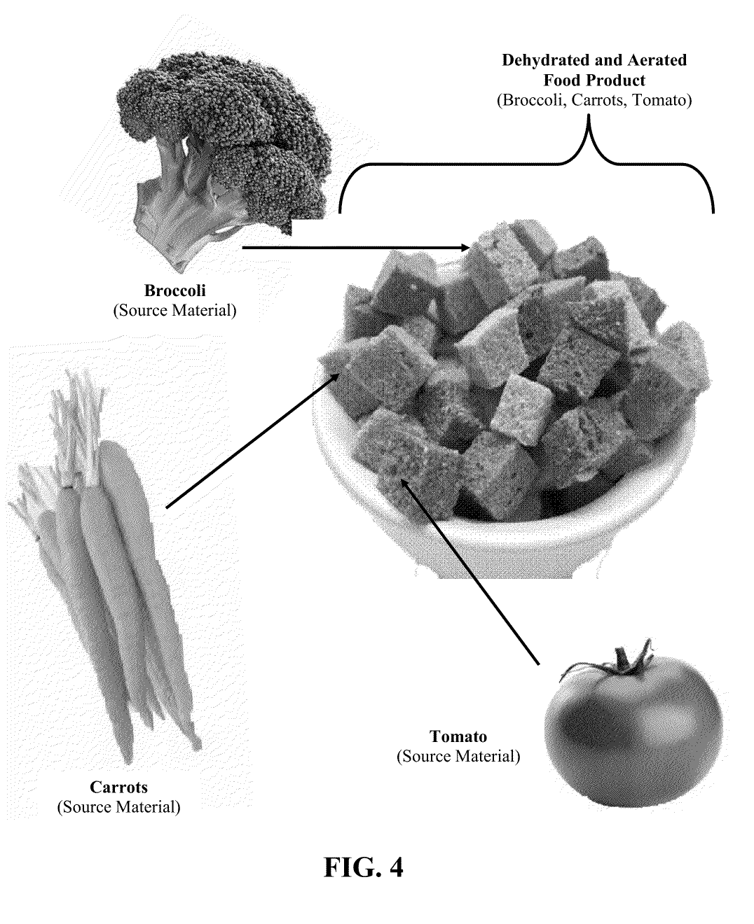

The dehydrated and aerated food product of the present invention is distinct over other existing food foams in that the plant puree mixture substantially retains the natural color it had prior to being combined with the hydrocolloid to form the dehydrated and aerated plant puree foam. The preservation of the natural coloration of the source plant material (i.e., the vegetable source, fruit source, or mixture of vegetables, fruits, or fruits and vegetables) can be determined by well known methods and instruments in the art, including, for example, using color reference charts, pigment content measuring instruments, HunterLab instructions, and the like. The preservation of its coloration can also be readily observed in FIGS. 2-8.

The dehydrated and aerated food product of the present invention is distinct over other existing food foams in that the plant puree mixture substantially retains the nutritive qualities it had prior to being combined with the hydrocolloid to form the dehydrated and aerated plant puree foam.

As used herein, the term “nutritive qualities” includes any measurable nutritive component or compound found in, and/or nutritive attribute of, the natural fruit or vegetable source. Also, it is understood that certain nutritive components and compounds can also fall under the category of nutritive attributes, as illustrated below. Suitable examples of nutritive components and compounds found in the natural fruit or vegetable source can include, without limitation, antioxidants, vitamins, polyphenols, tannins, anthocyanins, flavonoids, hydroxycinnamic acids, catechins, procyanidins, tocopherols, carotenoids, Betalain, Ellagic acid, and the like. Suitable examples of nutritive attributes of the natural fruit or vegetable source can include, without limitation, calories, total fat content, saturated fat content, unsaturated fat content, trans fat content, cholesterol content, sodium content, total carbohydrate content, dietary fiber content, sugars content, macronutrient content, and micronutrient content.

Methods of measuring the various nutritive qualities of the plant puree mixture and food product of the present invention are well known in the food science and food nutrition fields. With regard to measuring total antioxidant capacity of the plant puree mixture or food product of the present invention, one could employ the use of oxygen radical absorbance capacity (ORAC) methodology, which is well known in the art. In a particular method, carotenes (e.g., which are known to be broken down into vitamin A), vitamin C, and vitamin E can be used as antioxidant markers along with standard tests for detecting and quantifying these compounds. See Nielsen, S. S., 2010, Food Analysis, New York:Springer, which is incorporated herein by reference. Other methods for use in measuring and quantifying cellular antioxidant activity can include, without limitation, Cellular Antioxidant Activity (CAA), which is a cell-based fluorescent assay system for the measurement and quantification of cellular antioxidant activity (Wolfe, K. L. and Liu, R. H. (2007) Cellular antioxidant activity (CAA) assay for assessing antioxidants, foods, and dietary supplements. J. Agric. Food Chem. 55 (22): 8896-8907, and WO2009/036120, which are incorporated by reference herein).

As used herein, the term “hydrocolloid” refers to any colloid system having colloid particles that are dispersed in water. It is well known in the art that hydrocolloids can exist in various states, including, for example, as a gel or liquid (sol). The hydrocolloid of the present invention can be either reversible or irreversible (i.e., in a single state). The hydrocolloid of the present invention is one that is edible to the extent that it can be used in food products.

Further, when combined with the plant puree mixture according to the present invention, the hydrocolloid is effective to form a hydrocolloid-based aeration network dispersed throughout the plant puree mixture. In one embodiment, the hydrocolloid network is thermally reversible.

As used herein, the term “hydrocolloid-based aeration network” (also referred to as a “hydrocolloid network”) means an organized structure of hydrocolloid molecules dispersed within a plant puree substrate (e.g., the plant puree mixture of the present invention). Examples of the hydrocolloid-based aeration network of the present invention are illustrated in FIGS. 2-3. As shown in FIGS. 2-3, the hydrocolloid-based aeration network provides an open-cell structure to the plant puree mixture and assists in stabilizing the structure before and after dehydration. In various embodiments, the hydrocolloid-based aeration network results after the hydrocolloid and plant puree mixture are mixed and aerated. The hydrocolloid-based aeration network also allows for the forming of the food product into a desired shape prior to being dehydrated, with the desired shape being maintained after dehydration.

Unlike existing dehydrated/aerated food foams in the art (see, e.g., US-2011/0008515-A1), the dehydrated and aerated food product of the present invention does not require emulsifiers, including, for example, emulsifiers such as lactylated mono- or diglycerides. Emulsifiers are not required to stabilize the dehydrated and aerated food product of the present invention because all the ingredients of the food product are present in an aqueous phase. By way of contrast, other stable food foams like ice cream or whipped butter that contain lipid and aqueous phases require emulsifiers to stabilize the foam.

In addition, unlike existing dehydrated/aerated food foams in the art (see, e.g., US-2011/0008515-A1), the dehydrated and aerated food product of the present invention does not require the plant puree mixture/hydrocolloid combination to be thermally processed (e.g., at high temperatures such as 190 degrees Fahrenheit) prior to aeration or dehydration (e.g., freeze-drying), or after aeration or dehydration (e.g., freeze-drying).

Suitable examples of hydrocolloids for use in the present invention can include, without limitation, gelatin, pectin, carrageenan, alginate, starch, gum, modified starch, albumin (egg whites), agar, pea protein, whipped cream, and mixtures thereof. However, one of ordinary skill in the art can understand that other compounds that function as hydrocolloids can also be used in the present invention, as long as they are effective to be dispersed throughout the plant puree mixture to yield a hydrocolloid-based aeration network.

In one embodiment, the hydrocolloid is present in the dehydrated and aerated food product of the present invention in an amount ranging from about 1 percent by weight to about 35 percent by weight based on total dry weight. Although a beginning and ending percent by weight is provided for the hydrocolloid, the present invention is not limited to those upper and lower limits but also includes all percentages by weight falling within those upper and lower limits.

The dehydrated and aerated food product of the present invention has various attributes and qualities. Examples of some of these attributes and qualities are described below.

For example, the dehydrated and aerated food product of the present invention can have a density ranging from about 0.05 grams per cubic centimeter (g/cc) to about 0.2 g/cc. Although upper and lower limits are provided for the density of the food product of the present invention, the density of the food product of the present invention is not limited to those upper and lower limits but also includes all density values falling within those upper and lower limits.

As another example, the dehydrated and aerated food product of the present invention can have a moisture content ranging from about 0.05 percent to about 30 percent by weight based on total dry weight. Although upper and lower limits are provided for the moisture content of the food product of the present invention, the moisture content of the food product of the present invention is not limited to those upper and lower limits but also includes all moisture content values falling within those upper and lower limits.

As another example, the dehydrated and aerated food product of the present invention can have a water activity ranging from about 0.05 to about 0.5. Although upper and lower limits are provided for the water activity of the food product of the present invention, the water activity of the food product of the present invention is not limited to those upper and lower limits but also includes all water activity values falling within those upper and lower limits.

As another example, the dehydrated and aerated food product of the present invention can have an overrun of between about 2 percent and about 80 percent. Although upper and lower limits are provided for the overrun of the food product of the present invention, the overrun of the food product of the present invention is not limited to those upper and lower limits but also includes all overrun values falling within those upper and lower limits. The term “overrun” is well known in the food analysis arts. Methods of measuring and analyzing overrun of a food substance are also well known in the food analysis arts.

As another example, the dehydrated and aerated food product of the present invention can have a hardness value ranging from about 50 Newtons to about 180 Newtons. Although upper and lower limits are provided for the hardness of the food product of the present invention, the hardness of the food product of the present invention is not limited to those upper and lower limits but also includes all hardness values falling within those upper and lower limits.

As another example, the dehydrated and aerated food product of the present invention has advantageous friability qualities over the existing vegetable and fruit dried food products, including dried food foams. As used herein, the term “friability” refers to the ability of a solid substance to be reduced to smaller pieces with little effort. For foods where the consumer uses his or her hands and fingers to hold and manipulate the food for eating purposes, it is better for the food to have low friability. In other words, it is better that the food not crumble into smaller pieces when handled by the consumer. The dehydrated and aerated food product of the present invention is advantageous in that it has low friability.

In one embodiment, the dehydrated and aerated food product of the present invention further includes at least one food additive. The at least one food additive can be (i) added to the plant puree mixture prior to combining the plant puree mixture with the hydrocolloid, (ii) added to the hydrocolloid prior to combining the hydrocolloid with the plant puree mixture, (iii) added at the time of combining the plant puree mixture with the hydrocolloid, or (iv) added after combining the plant puree mixture with the hydrocolloid. Methods of adding the at least one food additive are known in the food arts and are further illustrated herein. Suitable food additives for use in the present invention can include, without limitation, a flavoring component, a coloring component, a nutritive additive, a nutritive sweetener, a non-nutritive sweetener, a seasoning component, yogurt, a spice component, a functional ingredient, protein additive, a dairy ingredient, and mixtures thereof. As specific examples, suitable food additives can include, without limitation, pumpkin pie spice, vanilla, chocolate, caramel, confectioners' sugar, spicy ranch-seasoning blend, cheese powder, such as one derived from Parmesan, etc. Other seasonings, flavors, spices, colors, or other additives or a blend of any of the before mentioned can also be used to create various tastes. The meanings of each of the above listed food additives are well known in the relevant art and some may be included in multiple categories (e.g., pumpkin spice could be both a flavoring component and a spice component).

The present invention also relates to a method of making a plant puree food product, which in one embodiment includes the dehydrated and aerated food product discussed herein. The method involves combining a plant puree mixture with a hydrocolloid under conditions effective to disperse the hydrocolloid throughout the plant puree mixture. The plant puree mixture/hydrocolloid combination is then aerated under conditions effective to yield a stable aerated plant puree foam. The aerated plant puree foam is then dehydrated using a non-heat-based dehydration process to yield the plant puree food product. The plant puree food product produced by this method includes a dehydrated and aerated plant puree foam having a hydrocolloid-based aeration network dispersed throughout the plant puree mixture.

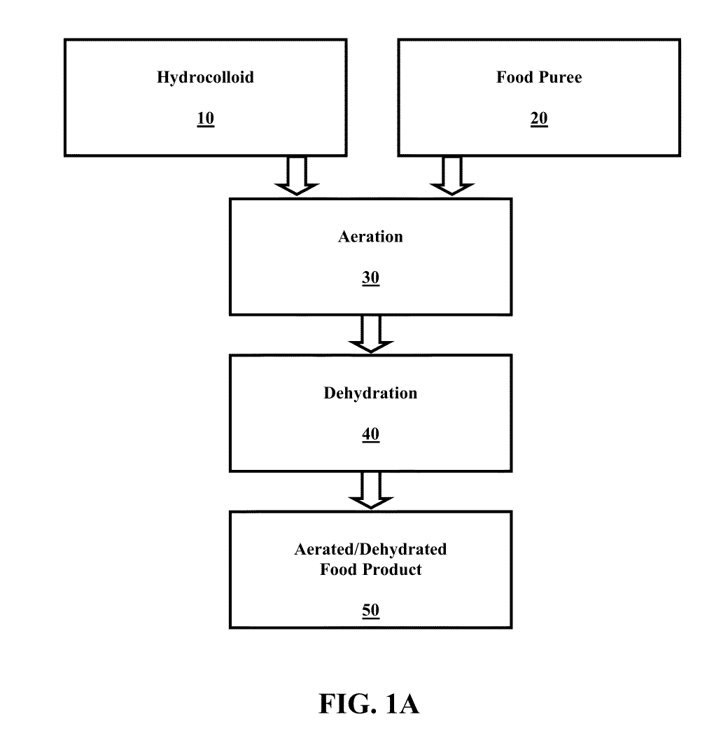

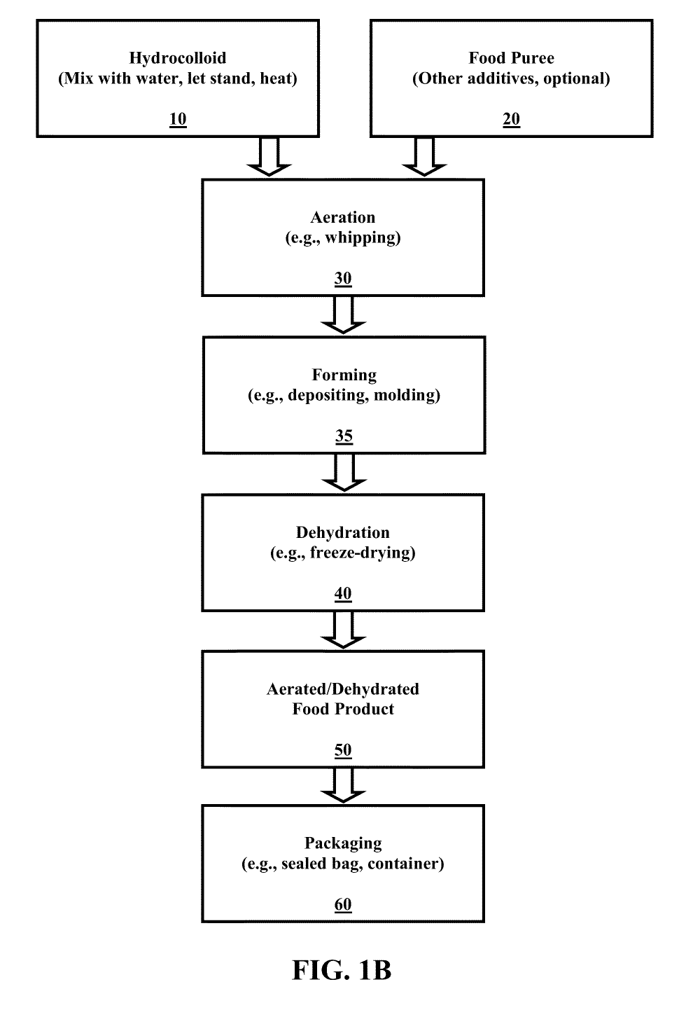

FIGS. 1A and 1B illustrate various embodiments of the method of making the plant puree food product of the present invention.

As shown in FIG. 1A, hydrocolloid 10 and food puree 20 (e.g., plant puree mixture) are combined and then subjected to aeration 30. The hydrocolloid and food puree may be combined before the aeration step or as part of the aeration step. Aeration 30 is effective to yield a stable aerated plant puree foam, which is then subjected to dehydration 40. In one embodiment, prior to dehydration 40, the stable aerated plant puree foam can be formed into a desired shape and size using standard shaping or molding techniques known in the food arts. After dehydration 40 (e.g., freeze-drying) the method yields aerated/dehydrated food product 50.

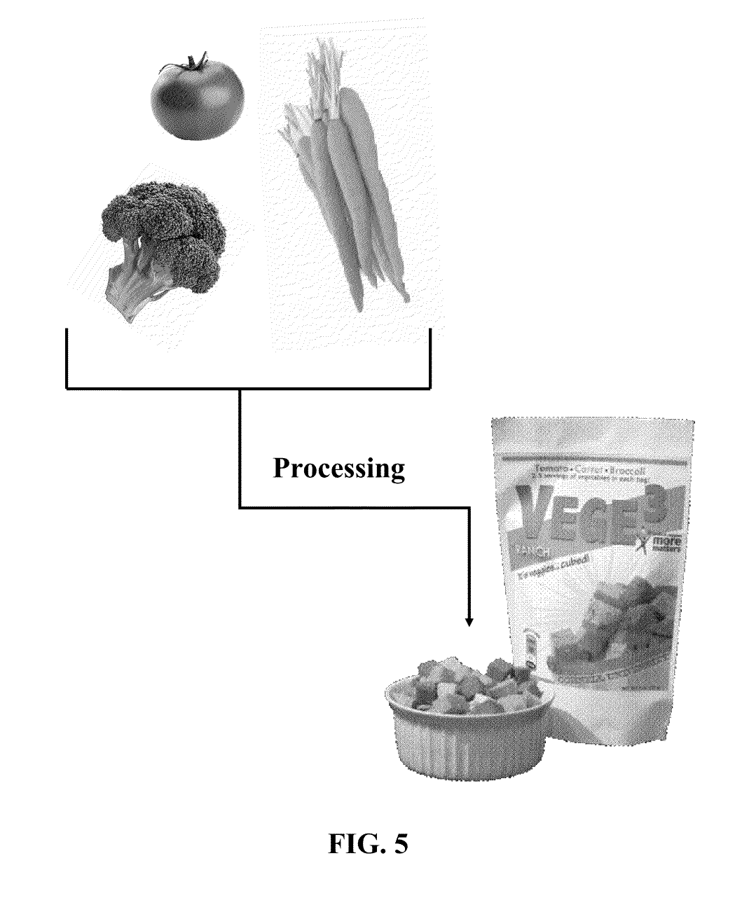

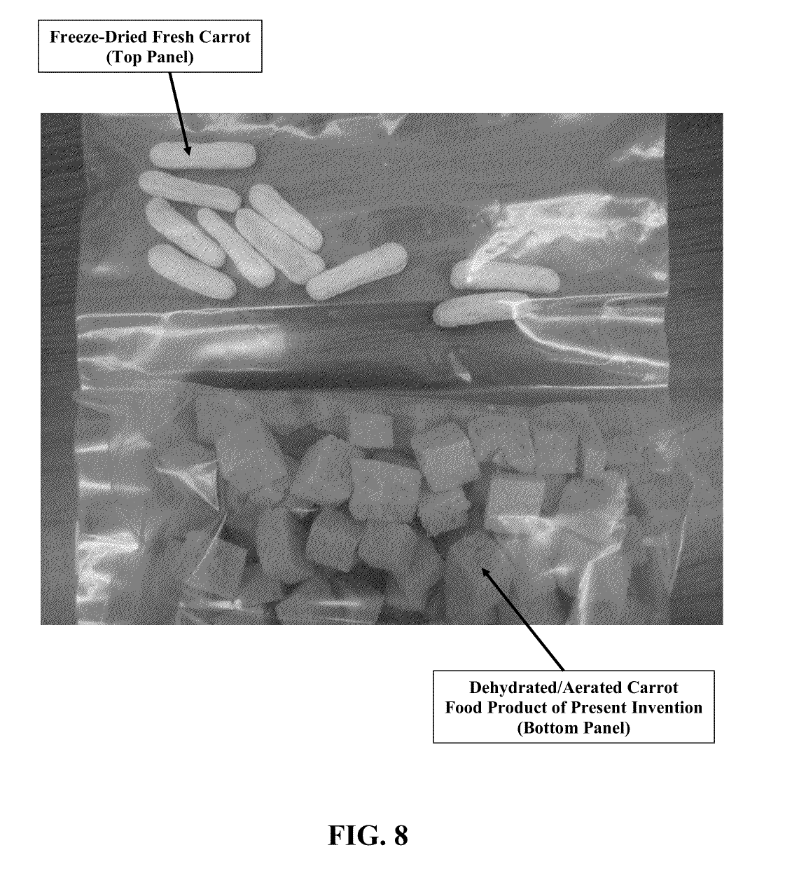

As shown in FIG. 1B, hydrocolloid 10 can undergo some preparation prior to being combined with food puree 20. For example, in one embodiment, hydrocolloid 10 can be mixed with water, allowed to stand for a period of time, and then subjected to heat. In a particular embodiment, hydrocolloid 10 can be heated to about 60 degrees Celsius after adding water thereto. Further, as shown in FIG. 1B, food puree 20 (e.g., the plant puree mixture) can be combined with other additives prior to being combined with hydrocolloid 10. However, such additives can also be added after hydrocolloid 10 and food puree 20 are partially or thoroughly mixed together. Aeration 30 can involve any technique known in the art that is effective to aerate the combined hydrocolloid 10 and food puree 20 in such a way as to produce the hydrocolloid-based aeration network described herein. Suitable techniques can include whipping, which is a well known technique in the food arts. After aeration 30, the resulting stable food foam can undergo forming 35, which involves forming the stable food foam into a desired shape and/or size. As noted herein, shaping techniques are well known in the art and can include, without limitation, deposition techniques, molding techniques, etc. In some embodiments, the shape can be a cube (e.g., like a crouton) (see FIGS. 2-8), a ball (e.g., like a malt ball), a wedge, or a replica of the source plant or plant part (e.g., a broccoli floret shape for a food product made from broccoli puree; a baby carrot shape for a food product made from carrot puree; a tomato wedge shape for a food product made from tomoto puree). After forming 35, the stable food foam can be subjected to dehydration 40 (e.g., freeze-drying), where the food foam is dehydrated using techniques that do not require heat treatments that degrade or substantially alter the coloration or nutritive qualities of the plant puree mixture portion of the combination. After yielding aerated/dehydrated food product 50, the product can then undergo packaging 60 in order to package the food product for storage and commercial sale. Packaging techniques for food foams are well known in the art and can include such packaging materials as sealed bags (see FIGS. 5 and 8), containers, etc. In some embodiments, the food product of the present invention can be packaged with other edible foods (e.g., Ramen noodles, crackers, etc.) in such a way to allow for reconstitution of the food product in water or other liquids.

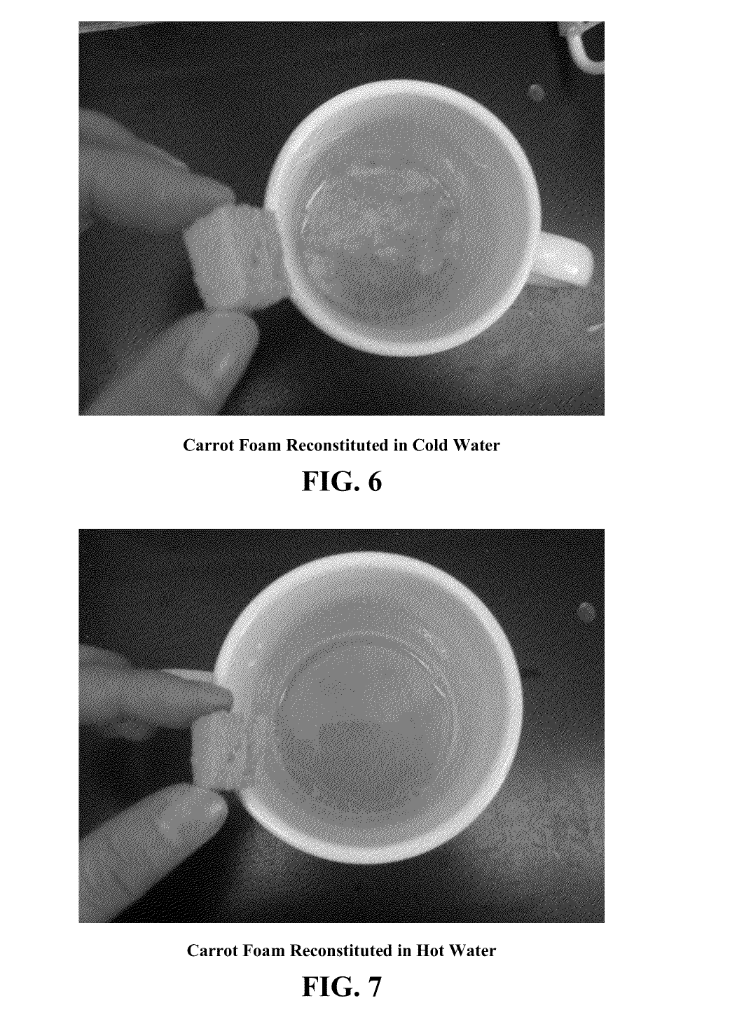

As shown in FIGS. 6-7, in various embodiments, the dehydrated/aerated food product of the present invention can be reconstituted in cold water (FIG. 6) or hot water (FIG. 7). Further, the food product of the present invention is such that it can be reconstituted in any temperature of water or liquid, whether it is a cold, warm, lukewarm, or hot liquid. Thus, the food product of the present invention can be useful for preparing cold beverages, hot beverages, sports drinks, soups, etc.

While not intending to be limited to a particular embodiment, including the embodiments shown in FIGS. 1A and 1B, below is a description of an embodiment of the method of the present invention. In one embodiment, the method begins by obtaining a food puree (e.g., fruit puree, vegetable puree, meat puree, dairy puree, mixtures thereof) and then combining it with a hydrocolloid such as a protein (e.g., gelatin), gum (e.g., agar), or starch (e.g., corn starch). Colors and/or flavors can also be added. An aerated foam is then created. Examples of foam creation methods can include, but are not limited to, the use of high shear mechanical agitation to create a foam or incorporation of compressed gas under pressure (as in whipped cream). The resulting foam can be formed into a desired shape or shapes. Examples of methods of forming can include, but are not limited to, extrusion, depositing, and molding. The product is then frozen and thereafter added to a freeze-drying apparatus where the moisture is removed under vacuum via sublimation, a process in which the moisture changes directly from solid to gas phase. In some embodiments, the resulting product has a water content of less than about 2% and commonly less than about 1% and that is stable when stored inside a moisture barrier package. After freezing is complete the shape can be modified further if desired.

The various starting materials for use in each of the steps are as described herein or as readily understood by those of ordinary skill in the art in view of the present disclosure. Particular illustrative embodiments of the steps for carrying out the method of the present invention are provided in the Examples section, but the present invention is not limited to just those illustrative embodiments.

Suitable plant puree mixtures for use in this method include the vegetable purees, fruit purees, meat purees, dairy purees, or mixtures thereof as described herein. In one embodiment, the plant puree mixture is provided as an aseptic puree mixture.

Suitable hydrocolloids for use in this method include the hydrocolloids as described herein.

In one embodiment, the method of the present invention is such that the combining, aerating, and dehydrating steps are performed so that the plant puree mixture substantially retains the natural color it had prior to being subjected to the combining, aerating, and dehydrating steps. The referenced natural color is as described above.

In one embodiment, the method of the present invention is such that the combining, aerating, and dehydrating steps are performed so that the plant puree mixture substantially retains the nutritive qualities it had prior to being subjected to the combining, aerating, and dehydrating steps. The nutritive qualities are as described above.

In another embodiment, the method of the present invention further includes the step of adding at least one food additive prior to the aerating step of the method of the present invention. As discussed above, and as reiterated herein below, the at least one food additive can be (i) added to the plant puree mixture prior to combining the plant puree mixture with the hydrocolloid, (ii) added to the hydrocolloid prior to combining the hydrocolloid with the plant puree mixture, (iii) added at the time of combining the plant puree mixture with the hydrocolloid, or (iv) added after combining the plant puree mixture with the hydrocolloid. Methods of adding the at least one food additive are known in the food arts and are further illustrated herein. Suitable food additives for use in the present invention can include, without limitation, a flavoring component, a coloring component, a nutritive additive, a nutritive sweetener, a non-nutritive sweetener, a seasoning component, yogurt, a spice component, a functional ingredient, protein additive, a dairy ingredient, and mixtures thereof. The meanings of each of the above listed food additives are well known in the relevant art.

In another embodiment, the method also provides that, prior to the combining step, the plant puree mixture and hydrocolloid are separately subjected to a sterilization procedure. In a particular embodiment, the sterilization procedure involves heat treatment.

In one embodiment, the method of the present invention further includes the step of forming the aerated plant puree foam into a desired shape, thereby yielding a plant puree food product having the desired shape. This step is performed prior to the dehydrating step of the method of the present invention. For example, as described herein, a plant puree food product made from broccoli can be formed into a broccoli floret, a plant puree food product made from tomatoes can be formed into a tomato fruit or tomato wedge, a plant puree food product made from carrots can be formed into a baby carrot or a carrot stick, a plant puree food product made from strawberries can be formed into a strawberry fruit or slice, a plant puree food product made from pears can be formed into a pear shape, etc. Further, one advancement of the method of the present invention over existing food foam technologies is that the present invention allows for the formation of shapes that are not possible by existing technologies, such as the formation of small and large extruded bars (e.g., bars having a weight of between 0.1-200 grams). Thus, the food product of the present invention can also be used form layers on such food items as nutrition bars or candy bars. For example, a food product of the present invention made from strawberry puree can be used to add a layer of strawberry to a food bar, or the food product can be used as the core of the food bar with a coating added around the food product. Suitable coating technologies are well known in the food arts.

Various techniques known in the food processing arts can be used to form the aerated plant puree foam into a desired shape, including, without limitation, deposition processes, extrusion processes, and molding processes.

In one embodiment, the method involves the use of a non-heat-based dehydration process. This allows for the substantial preservation in the plant puree food product of various attributes and characteristics of the source plant material as found in the plant puree mixture prior to dehydration. As used herein, the term “non-heat-based dehydration process” refers to any dehydration process that does not require heating as a primary component to dry a food material. Suitable examples of non-heat-based dehydration processes according to the present invention can include, without limitation, freeze-drying, vacuum-drying, or any other assisted freeze-drying method.

In a particular embodiment, the step of dehydrating includes freeze-drying the aerated plant puree foam in a freeze-dryer that has a condenser. In this embodiment, the aerated plant puree foam is cooled in the freeze-dryer to a temperature of between about −60 degrees Celsius and about 0 degrees Celsius at a pressure from about 10 Pascal (Pa) to about 98,000 Pa. Thereafter, the temperature is adjusted by gradually increasing the temperature inside the freeze-dryer to between about 15 degrees Celsius and about 30 degrees Celsius while maintaining the temperature of the condenser at between about −70 degrees Celsius and about −10 degrees Celsius. Thereafter, the aerated plant puree foam is incubated in the freeze-dryer until the internal temperature of the aerated plant puree foam is substantially equal to ambient temperature.

In another particular embodiment, the aerated plant puree foam can be cooled to a temperature of about −40 degrees Celsius during the cooling step.

In a further particular embodiment, the aerated plant puree foam can be cooled at a pressure of about 26 Pa during the cooling step.

In another particular embodiment, the step of adjusting the temperature can include increasing the temperature inside the freeze-dryer to about 24 degrees Celsius while maintaining the temperature of the condenser at about −60 degrees Celsius. In yet another particular embodiment, freeze-drying can be at about −40 degrees Celsius to about 24 degrees Celsius in 24 hours at about 26 Pa.

The present invention is not limited to just the freeze-drying parameters explicitly described herein, as those of ordinary skill in the art can adjust the parameters without undue experimentation to yield the same or substantially the same desired results of the method of the present invention based on the disclosure provided herein.

Freeze-drying of the aerated plant puree foam as described herein was found to provide significant advantages over other dehydration methods such as heat-based dehydration. For example, traditional heat-based dehydration methods caused the aerated plant puree foam to collapse, while the freeze-drying method used in the present invention allowed the aerated plant puree foam to maintain its shape. Further, the present invention methodology (e.g., aeration and freeze-drying) is effective in producing a dehydrated and aerated food product having a unique thermoreversible structure, which allows the hydrated food product to melt at body temperature, leading to a more enjoyable eating experience. In particular, due to the thermoreversibility of the food product of the present invention, the first bite of the food product by the user results in a crunching sensation, but subsequent bites do not result in the food product getting stuck in the user's teeth.

In another aspect, the present invention relates to a plant puree food product produced according to the method of the present invention. As used herein, the term “plant puree food product” produced by the method of the present invention includes the “dehydrated and aerated food product” and the “hydrocolloid stabilized dehydrated food foam” described herein.

In a further aspect, the present invention relates to a combination food product that includes a dehydrated and aerated food product according to the present invention combined with another edible foodstuff. Therefore, the present invention includes any combination food product that contains the dehydrated and aerated food product of the present invention.

The combination food product of the present invention can be in any form suitable for combining the dehydrated and aerated food product with another edible foodstuff. Suitable forms of the combination food product of the present invention can include, without limitation, a bar (e.g., nutrition bar, candy bar, etc.), trail mix, drink mix, cereal, dry soup mix, noodle mix, dietary supplements, and the like. In various embodiments, the dehydrated and aerated food product of the present invention is packaged separately from the edible foodstuff, and can later be combined with the edible foodstuff or other ingredients (e.g., liquids such as water or soup broth) at the time of or prior to consumption by the user. In other embodiments, the dehydrated and aerated food product of the present invention can be packaged in the same packaging material as the edible foodstuff, as well as any other ingredients (e.g., flavorings, garnishments, etc.) for consumption by the user along with the combination food product.

In one embodiment, the combination food product is such that the dehydrated and aerated food product is provided in a sealed container, along with or separate from the edible foodstuff. Suitable sealed containers can include, without limitation, containers configured as bowls, bowl-like structures, bags (e.g., pouches), bottles, and the like. In particular embodiments, these suitable sealed containers are designed to allow for combining the dehydrated and aerated food product with a liquid in order to reconstitute the dehydrated and aerated food product into a liquid puree (see FIGS. 6-7).

In order to further illustrate aspects of the present invention, provided below is another embodiment of the method of making the plant puree food product of the present invention. While specific steps, ingredients, and parameters are provided below, the present invention is not intended to be limited thereto.

In a particular embodiment, the method involves mixing/whipping of the components by performing the following steps:

Hydrocolloids are mixed with cold water for about 1 minute to about 15 minutes and allowed to stand for about 1 minute to about 10 minutes, to allow for sufficient water absorption and blooming. The solution is then heated from about 10° C. to about 90° C. In one example, the hydrocolloid is gelatin. In one example, the time of mixing the hydrocolloid is five minutes. In one example, the heating temperature is 60° C.

Additional ingredients such as seasoning(s), spices(s), flavoring(s), coloring(s), and/or other functional ingredient(s) can then added, if desired, to the vegetable, fruit, plant, and/or meat puree(s) and mixed together to achieve a homogenous mixture. Mixing may be performed by, but not limited by, whisk, blender, mixer, shaker, beater, or compressed air incorporation.

The hydrocolloid solution is added to the puree component and this combination is whipped at high power for about 1 minute to about 15 minutes to disperse the hydrocolloid and incorporate the air that assists in creating a stable foamed gel. In one example, the whipping occurs for 5 minutes. The addition of the hydrocolloid reduces the friability of the dried pieces resulting in a more stable product with less broken pieces, crumbs or powder.

The foamed food gel is then sheeted onto slabs and, if desired, cut into shapes. A variety of regular and irregular shapes can be made, such as cubes, disks, and sticks. The foamed gel can also be formed and deposited in a continuous manner or can be piped into various designs.

The foamed food gel is then dehydrated. One example is to freeze-dry by cooling to a temperature from about −60° C. to about 0° C., and at a pressure from about 10 Pa to about 98000 Pa. The air temperature is gradually increased inside the freeze-dryer to about 15° C. to about 30° C., while keeping the condenser temperature at about −70° C. to about −10° C. The process is complete when the internal product temperature equals the ambient temperature, which can take from about 10 hours to about 48 hours, and in one particular example it may take 24 hours. Microbial and nutrient stability are achieved through this step. In one embodiment, the initial cooling temperature is −40° C. In another embodiment, the pressure is 26 Pa. In a further embodiment, the temperature is increased to 24° C. and the condenser temperature is −60° C.

The finished product may be packaged and flushed with nitrogen gas. As one example, polymer/aluminum foil laminated stand-up pouches provide a good oxygen and moisture barrier.

Without intending to be bound by a particular theory, in one aspect, the crunchy texture of various embodiments of the food product of the present invention is a result of the hydrocolloid-based aeration network, hydrocolloid stabilization, and the dehydration process (such as freeze-drying). Pureeing food pulverizes their structure and a colloid stabilizing agent forms a binding that is capable of holding the foamed puree into a stable product. In one particular embodiment, gelatin was used to stabilize the vegetable foam because it provides a gel structure and forms a thermally reversible gel that melts below body temperature. This property gives a pleasant mouthfeel after chewing and reduces the perception of gumminess. Other colloids like starches, gums, and proteins can also be used.

As noted herein, the food product of the present invention can be made into a tasty, healthy snack when incorporating a plant puree, such as one derived from vegetables and/or fruits. Because the product has very low moisture content (e.g., from about 0.1% to about 5%) and low water activity (e.g., aw <0.5), microbial growth and nutrient degradation are effectively inhibited.

The use of vegetable, fruit, and/or meat purees as a starting material provides certain sensory benefits that are otherwise not achievable; including retention of the naturally occurring vibrant colors, allowance for addition of flavors and seasonings, as well as the flexibility of forming various shapes.

### EXAMPLES

The following examples are intended to illustrate particular embodiments of the present invention, but are by no means intended to limit the scope of the present invention.

### Example 1

### Preparation of Vegetable or Fruit Puree Foam

One method of preparing a vegetable (e.g., broccoli, carrot, etc.) or fruit (e.g., tomato, strawberry, etc.) puree foam of the present invention is described below.

Weighing: Ingredients are removed from storage and accurately weighed to ensure a deviation no larger than 1% from the target weight specified in the formulation.

Mixing/Aeration: This operation involves three steps:

(1) Gelatin is first gently mixed with cold water (municipal tap, <10° C.) for 1 minute and held for 5 minutes for sufficient water absorption. The mixture is then heated to 60° C. to completely dissolve gelatin into solution.

(2) The remaining ingredients (individual vegetable or fruit puree, seasonings, and cheese powder) are blended using a mixer to achieve a homogenous slurry.

(3) After adding the gelatin solution into the puree mix, the mixture is aerated using mixer at high speed for 5 minutes to disperse the gelatin and incorporate air that creates a stable foam.

Forming: The stable vegetable or fruit foam is then deposited onto freeze-drying trays with 1.5 cm thickness, and then cut into desired shapes. A variety of regular and irregular shapes can be made, including disk and rod shapes.

Freeze-drying: For this step, the product is cooled to −40° C., and the pressure is reduced to 26 Pa. Afterwards, the air temperature is gradually increased inside the freeze-dryer to 24° C., while keeping the condenser temperature at −60° C. The process is complete when the internal product temperature equals the ambient temperature, in this case, in about 24 hours.

Packaging: Each package is composed of 10 g of each individual vegetable or fruit cube (broccoli, carrot and tomato) and is N2 flushed. Polymer/aluminum foil laminated stand-up pouches provide a good oxygen and moisture barrier.

### Example 2

### Sweet Potato Formulation (Whipped Cream)

A sweet potato food foam according to the present invention was prepared using the following ingredients, materials, and procedures:

Ingredients: ¾ cup Heavy Cream; ¼ cup Sweet Potato Puree; ½ cup (50 g) Confectioners' Sugar; and ⅛ tsp Vanilla Extract.

Materials: Digital scale; KitchenAid stand mixer w/whisk attachment; and Refrigerator.

Procedure: (1) Measure out all ingredients. (2) Combine in KitchenAid bowl. (3) Whisk on high until soft peaks form (˜5 mins). (4) Chill until needed.

Notes: (1) Once freeze dried, the texture melts well in your mouth. (2) Chill the bowl to get quicker whip.

### Example 3

### Sweet Potato Formulation (Nitrous Gelatin)

A sweet potato food foam according to the present invention was prepared using the following ingredients, materials, and procedures:

Ingredients: 2 tsp/9 g Knox Original Gelatine (Powdered Gelatin); ½ cup Water; ¼ cup Sweet Potato Puree; and ¼ tsp McCormick Pumpkin Pie Spice.

Materials: Digital scale; Medium bowl; Small saucepan; Stovetop; Refrigerator; iSi pint size, stainless steel cream whipper; and iSi nitrous cream whipper charger.

Procedure: (1) In a medium bowl combine sweet potato puree and pumpkin spice. (2) In a small saucepan combine the gelatin and water. (3) Put the saucepan over medium-high heat while whisking constantly. (4) Bring the mixture to a simmer or until all gelatin is incorporated. (5) Add the warm homogeneous gelatin/water mixture to the puree and spice. (6) Whisk/stir the contents of the bowl until combined. (7) Add the contents of the bowl to the iSi whipper container and screw on top. (8) Refrigerate the container for 30 minutes. (9) Remove from refrigerator (contents should be solid). (10) Add the nitrous charger by placing the small side towards the container contents (screw the nitrous charger on quickly so that all the nitrous enters the container). (11) Ensure that the top is on tightly, then shake the container upside down (this will allow the contents to go towards the nozzle and the nitrous to combine). (12) Squeeze the handle to propel out the foam. (13) Shake upside down after each foam. (14) Once the contents are removed, continue squeezing the handle to release pressure.

Notes: (1) Tap water was used in this trial, but one may use distilled water. (2) One alternative is to reduce the pumpkin spice to ⅛ tsp. (3) Less gelatin could be used in order to prepare a less stiff foam.

### Example 4

### Sweet Potato Formulation (KitchenAid Gelatin)

A sweet potato food foam according to the present invention was prepared using the following ingredients, materials, and procedures:

Ingredients: 2 tsp/9 g Knox Original Gelatine (Powdered Gelatin); ½ cup Distilled Water; ¼ cup Sweet Potato Puree; ¼ tsp McCormick Pumpkin Pie Spice; and ¼ cup (25 g) Confectioners' Sugar.

Materials: Digital scale; KitchenAid bowl; Small saucepan; Stovetop; and KitchenAid with whisk attachment.

Procedure: (1) In a KitchenAid bowl combine sweet potato puree and pumpkin spice. (2) In a small saucepan combine the gelatin and water. (3) Put the saucepan over medium-high heat while whisking constantly. (4) Bring the mixture to a simmer or until all gelatin is incorporated. (5) Add the warm homogeneous gelatin/water mixture to the puree and spice. (6) Whisk on high until a light foam forms.

Notes: (1) One may reduce the pumpkin spice to ⅛ tsp (spice builds in mouth). (2) Less gelatin could be used, because a synthetic texture resulted. Less gelatin would cause it not to rise as high which would freeze dry more uniformly and produce fewer deflated craters in the final product. (3) Texture was similar to a rice cake (good initial crunch).

### Example 5

### Sweet Potato Formulation (KitchenAid Starch)

A sweet potato food foam according to the present invention was prepared using the following ingredients, materials, and procedures:

Ingredients: 10% Starch (based on weight); ½ cup Distilled Water; ¼ cup Sweet Potato Puree; ¼ tsp McCormick Pumpkin Pie Spice; and ¼ cup (25 g) Confectioners' Sugar.

Materials: Digital scale; KitchenAid bowl; Small saucepan; Stovetop; and KitchenAid with whisk attachment.

Procedure: (1) In a KitchenAid bowl combine sweet potato puree and pumpkin spice. (2) In a small saucepan combine the starch and water. (3) Put the saucepan over medium-high heat while whisking constantly. (4) Bring the mixture to a simmer or until all starch is incorporated. (5) Add the warm homogeneous starch/water mixture to the puree and spice. (6) Whisk on high.

Notes: (1) One may reduce the pumpkin spice to ⅛ tsp (spice builds in mouth). (2) Starch leads to thicker solution (not as aerated).

### Example 6

### Broccoli, Carrot, and Tomato Puree Foam Cubes

This example describes the broccoli, carrot, and tomato puree embodiments of the dehydrated and aerated food product of the present invention, as well as particular embodiments of making the food product. The dehydrated and aerated food product described in this example is also referred to as “vegetable cubes” (but also can be understood to include fruit cubes, e.g., tomato is used herein as both a fruit and vegetable, even though it is well known in the art to be considered a fruit).

### Product Description

The vegetable cubes of the present invention are a unique product of freeze-dried vegetable puree foams, consisting of broccoli, carrot, and tomato cubes. Each cube is blended with ranch seasoning to create a savory, crunchy snacking experience, while preserving the wholesome nature of real vegetables. This lightly seasoned, shelf stable vegetable snack provides the satisfaction of your favorite munchies without the guilt. Each 30 g package holds a colorful display of cube-shaped pieces that reveal bright appetizing colors naturally found in broccoli, carrots, and tomatoes without any additional colorings or preservatives. These three vegetables are most regularly purchased by more than seven in ten consumers (1) and were the most popular vegetables listed by consumers (n=301) in an online survey. Each serving of vegetable cubes contains 2.5 servings of vegetables, and 4 g fiber, with only 100 calories and 0.5 g of fat. This delicious snack delivers the health benefits of vegetables, which have been shown to reduce the risks of obesity, stroke, high blood pressure, and diabetes, as well as some forms of cancer (2). The vegetable cubes meet the strict nutrition requirements of the “Fruits and Veggies-More Matters™” claim, which can be displayed on the front label panel to encourage the purchase of the product and to emphasize the importance of daily consumption of fruits and vegetables.

### Formulation/Ingredient Functionality

The formulation of the vegetable cubes and function of each ingredient is described in Table 1. The use of vegetable purees provides flexibility to the food product appearance, as they can be made into different shapes and textures by incorporating a structural agent; flavors can also be easily incorporated. Purees also provide a pricing advantage compared to whole vegetable pieces because they can utilize scrap material from other vegetable processing operations such as production of baby carrots or frozen broccoli florets. Because the vegetable structure is destroyed by the pureeing process, a structural agent is required so that it will retain its shape and will not fall apart during processing. Gelatin was chosen as the structural agent because it facilitates whipping the puree into a stable foam, which will set into a rigid gel upon cooling. Gelatin imparts crunchiness to the freeze-dried product and reduces the friability in the package. It also exhibits significantly less gumminess or tooth packing compared to some other hydrocolloids, due to the reversibility of the gel at body temperature.

TABLE 1
Vegetable Cubes Formulation and Functionality

| Ingredient | Dry Weight/Serving (g) | Functionality |
|---|---|---|
| Broccoli Puree | 4.6 | Serving of Broccoli, color, |
| | | flavor and solids |
| Carrot Puree | 5.4 | Serving of Carrot, color, |
| | | flavor and solids |
| Tomato Puree | 5.4 | Serving of Tomato, color, |
| | | flavor and solids |
| Yogurt, Non-fat Greek | 2.4 | Provides dairy note, |
| | | protein, and calcium |
| Gelatin | 7.9 | Provides structure and |
| | | thermoreversible gel, |
| | | aeration agent |
| Buttermilk Powder | 2.5 | Seasoning, dairy note |
| Garlic Powder | 0.5 | Seasoning |
| Onion Powder | 0.5 | Seasoning |
| Salt | 0.5 | Seasoning |
| Milk Powder | 0.1 | Seasoning |
| Total Dry Weight | 29.8* | |

*This is the total dry weight; it does not include 2% moisture

The other ingredients (yogurt, buttermilk powder, garlic powder, onion powder, salt, and milk powder) are added to give the product an authentic ranch flavor that will combine two familiar experiences, veggies and ranch dip, as well as ranch flavored chips.

### Nutritional Information

The vegetable cubes of the present invention are a nutritional powerhouse, in one serving (30 g) they provide more than 2.5 servings of vegetables, as defined by the reference amount customarily consumed (RACC) for vegetable puree in the Code of Federal Regulations (CFR) (1 serving of vegetables=60 g of vegetable puree) and (3). The vegetable cubes are low in fat, an excellent source of vitamin A and vitamin C, and a good source of fiber, calcium and iron (4).

### Process Description

In view of the current disclosure and knowledge in the art, the methods for receiving, storing, and measuring (e.g., weighing) the ingredients used in the method of making the food product of the present invention are readily determined by those of ordinary skill in the relevant art. Thus, these steps are not reiterated here. However, provided below are descriptions of particular aspects of an embodiment of the method of the present invention.

Mixing/Whipping (QCP2):

Mixing and whipping is a part of the method of the present invention. In one embodiment, this operation involves three steps:

(1) Gelatin is first mixed for 1 minute with cold water and allowed to stand for 5 minutes, in a steam jacketed kettle to allow for sufficient water absorption and blooming. The solution is then heated to 60° C. and gently mixed for 1 minute before being added to the vegetable slurry via the continuous mixer in step 3.

(2) The remaining ingredients (vegetable puree, seasonings, and yogurt) are combined and blended together for 5 minutes to a homogenous slurry using a hydraulic slurry mixer equipped with load cells to record batch weights (6).

(3) The gelatin and vegetable slurries are combined together in an Oakes® continuous mixer. The two streams can be combined and aerated into a consistent density using the rotor-stator mixing design. The advantage of the Oakes® mixer is that the rotor-stator design and incorporation of compressed air into the product creates consistent aerated foam (6).

Depositing:

The foamed vegetable gel is then transferred directly from the continuous mixer into an overhead depositor. Initially, the overhead depositor will be used with a die to directly deposit cubes on the freeze drying tray. For potential line extensions which require more detailed shapes, sheet depositing and stamping may be used.

Freezing:

The deposited vegetable foam is sent through a single pass impingement tunnel freezer to be rapidly frozen at −40° C., requiring approximately 158 BTU/lb of material (7). Frozen material is stored on trays in a freezer until being freeze dried.

Freeze-Drying (CCP2, QCP3):

Microbial and nutrient stability are achieved through this step. The frozen product will enter the freeze drier through the “Pizza Door” with a single height loading Once the shelf and product temperature controls reach −40° C., the pressure is reduced to 200 MT (26 Pa). The shelf temperature is gradually increased inside the freeze-dryer to 24° C., while keeping the condenser temperature at −60° C. The process is complete when the internal product temperature equals the ambient temperature, which takes about 24 hours. This is dependent on the amount of material to be freeze dried, the water present in the material, and how tightly bound the water is. The Millrock Quanta 320 freeze drier can condense 600 litter of water in a 24 hour period (8), thus freeze drying about 650 kg of vegetable foam into 65 kg of finished product in 24 hours. The Programmable Logic Controller (PLC) will be programmed to ensure that the product is completely dry. The software is equipped with technology that complies with 21 CFR Part 11 to meet the needs of GMP requirements for traceability. All programs, monitoring data, and records of any program changes will be stored on a secure SQL database to provide an audit trail.

Packaging (QCP4):

Each 30 g package is composed of 10 g of each variety of vegetable cubes (broccoli, carrot, and tomato). A horizontal form, fill, and seal (FFS) packaging machine capable of producing nitrogen flushed stand-up pouches will be used.

Other post-production steps can be performed as well, including, for example, metal detection to check to make sure that no physical contaminant is included in the finished product.

### Technical Problem Solving

Appearance:

Freeze drying was used to preserve the vibrant colors naturally occurring in the vegetables without adding additional color ingredients. The natural colors in the vegetable cubes are protected during the product shelf life by using a packaging material with good light, oxygen, and moisture barrier properties.

Texture:

To achieve a crunchy texture similar to extruded snacks, an aerated structure is needed and a low water activity has to be achieved in the product. Traditional freeze drying of vegetable puree results in vegetable powder, which is usually used as an ingredient. To achieve an aerated structure using vegetable puree, gelatin was chosen because of its foaming capability and thermal reversibility. This property is important for aeration structure forming and setting upon cooling, and also for a pleasant mouthfeel, which reduces the gumminess compared to gums and starch. Freeze drying process is used to reduce the water activity level to achieve the crunchy texture, and due to open foam structure and large drying surface areas of the vegetable puree foam cubes, moisture can be driven out of the matrix faster than freeze drying of vegetable pieces.

A Balance Between Taste and Nutrition:

Freeze dried vegetable pieces are usually coated with seasonings, such as Crunchies® Veggie Crunchies. This may cause localized seasonings or under seasoned products and it also increases the total fat content of the products. By using puree and blending seasonings into the liquid phase before freeze drying, the vegetable cubes of the present invention can be uniformly seasoned to provide the same delicious taste in every bite and a mess-free experience for the consumer. In order to meet the strict nutrition requirements for the “Fruits and Vegetables—More Matters™” claim, each serving of a product such as the food product of the present invention must deliver at least 1 serving of vegetables with less than 8 calories from added sugars or caloric sweeteners and less than 3 grams of total fat per serving. Blending in seasonings, instead of coating seasonings, reduces the fat content in the food product. In addition, replacing the traditional ranch ingredients of sour cream and buttermilk with fat free yogurt and low fat buttermilk powder also helps lower the fat content while providing the sour dairy flavors and not compromising the taste.

### Packaging Selection and Shelf Life Estimate

Resealable polymer/foil laminated stand-up pouches are selected as the primary packaging to provide a good moisture barrier and prevent oxygen permeation as well as light exposure. This will not only guarantee the natural color retention, but also ensure the freshness and texture acceptance of the product over the two-year shelf life, a length of time comparable to shelf stable snack products that are currently on the market, such as Crunchies® Veggie Crunchies (18 months). Due to a very low moisture content (<2%) and low water activity, (Aw <0.2), microbial growth and nutrient degradation are effectively inhibited. Quality changes will occur when water activity increases to 0.35-0.50 over its shelf life (9). The experimental data of moisture sorption isotherm curves for potato chips and saltine crackers indicated that the corresponding moisture contents are 0.045 g water/g solids at Aw 0.2 and respectively 0.06 g water/g solids at Aw 0.35 (9). To conservatively estimate shelf life based on the data for these relatively similar products, the end of the vegetable cubes' shelf life was decided as the point where the total moisture uptake reaches 0.45 g, and detectable texture change occurs. The stand-up pouches have a dimension of 7″ width×4″ bottom gusset×11½″ height for a total effective area of 175 in². The water vapor transmission rate of the packaging film is less than 0.005 gram/100 in²·24 hr (0.0003 measured), which will allow up to 2 years and 4 months of shelf life if unopened and under proper storage conditions (22° C./<55% RH). The head space will be nitrogen flushed to limit oxidative degradation of vitamins and colors. The “Best if Used By Date” will be clearly labeled on the packaging panel and two-year shelf life will be indicated, which is consistent with other freeze dried food products on the market (10). Single wall corrugated paperboard will be used as secondary packaging to ensure the integrity of the products during shipping and handling.

### Originality

In one embodiment, the vegetable cubes of the present invention are a unique vegetable snack made from a freeze-dried, cubed shaped vegetable foam with ranch seasoning blended uniformly throughout each cube to boost the taste. Using vegetable puree as a starting ingredient not only lowers the ingredient cost compared to using whole vegetable pieces, it also provides an opportunity to shorten freeze drying time as there is more surface area per volume and more open pores compared to the whole vegetable pieces, thus reducing energy cost.

Several “vegetable-based” chips or treats on the market are designed to have vegetable-like colors or shapes to purport a “better-for-you” benefit. As appealing as they are, a majority of these snacks are starch-based or high in fat content due to frying, drying, or coating with oil and seasonings. On the other hand, freeze-dried whole vegetables without such coatings often lack the bold flavors of the food product of the present invention. In a particular embodiment, the vegetable cubes of the present invention offer 2.5 servings of vegetables, 4 g of fiber, and a low fat content (0.5 g) per package (30 g), which makes it a great choice over other baked and fried vegetable-type snacks. Seasonings blended within each cube provide a great taste, while leaving fingers free of powdered flavor coatings and oil residue. A single-serve package provides a more convenient way to snack than raw vegetables. On the whole, the ability of the vegetable cubes of the present invention to combine high nutritional value, savory flavor, crunchy texture, and appealing appearance makes it a one of a kind snack.

### Example 7

### Formulations of Various Food Products of the Present Invention

Provided below are formulations of various dehydrated and aerated food products of the present invention. These formulations are illustrative and are not meant to be limiting on the present invention.

TABLE 2
Broccoli, Tomato, and Carrot Formulation

| | % | Wet Weight | Dry Weight/Serving |
|---|---|---|---|
| | Formula | (g) | (g) |
| Aseptic Broccoli | 30% | 48.7 | 4.8 |
| Puree | | | |
| Aseptic Tomato | 30% | 48.4 | 6.3 |
| Puree | | | |
| Aseptic Carrot Puree | 29% | 47.1 | 4.7 |
| Parmesan Cheese | 4% | 7.1 | 5.7 |
| Powder | | | |
| Gelatin | 4% | 7.1 | 5.9 |
| Flavor | 2% | 2.5 | 2.5 |
| Total/Serving | 100% | 161.1 | 30.0 |

TABLE 3
Carrot Formulation

| | | Weight | Dry | % Dry | Actual |
|---|---|---|---|---|---|
| Carrot | | (g) | Weight | Weight | Weight |
| Frozen Carrot | ½ cup | 180 | 18 | 52% | 252 |
| Ranch Powder | | 5 | 5 | 15% | 7 |
| Yogurt | | 18 | 2.7 | 8% | 25.2 |
| Water (for Puree) | | 90 | | | 126 |
| Water (for gelatin) | | 60 | | | 84 |
| Gelatine | | 10 | 8.7 | 25% | 14 |
| | | 363 | 34.4 | 100% | 508.2 |
| | | | 0.094766 | | |

Comments: swelled gellatin in cold water, heated in microwave on low temperature for 40 sec to approximately 60° C. Combined puree and flavor in kitchenaid. Mixed with whisk attachment on high. Added melted gelatin, Whipped, to a chunky texture 5 min

TABLE 4
Tomato Formulation

| | | Weight | Dry | % Dry | Actual |
|---|---|---|---|---|---|
| Tomato | | (g) | Weight | Weight | weight |
| Tomato Puree | ½ cup | 265 | 34.45 | 68% | 371 |
| Ranch Powder | | 5 | 5 | 10% | 7 |
| Yogurt | | 18 | 2.7 | 5% | 25.2 |
| Water (for | | 60 | | 0% | 84 |
| gelatin) | | | | | |
| Gelatine | | 10 | 8.7 | 17% | 14 |
| | | 358 | 50.85 | 100% | 501.2 |
| | | | 0.142039 | | |

Comments: swelled gellatin in cold water, heated in microwave on low temperature for 40 sec to approximately 60° C. Combined puree and flavor in kitchenaid. Mixed with whisk attachment on high. Added melted gelatin, Whipped, to a chunky texture 5 min

TABLE 5
Broccoli Formulation

| | Weight | Dry | % Dry | |
|---|---|---|---|---|
| Broccoli | (g) | Weight | Weight | Actual Weight |
| Frozen Broccoli | 180 | 16.74 | 51% | 252 |
| Ranch Powder | 5 | 5 | 15% | 7 |
| Yogurt | 18 | 2.7 | 8% | 25.2 |
| Water (for | 90 | | | 120 |
| Puree) | | | | |
| Water (for | 60 | | | 84 |
| gelatin) | | | | |
| Gelatine | 10 | 8.7 | 26% | 14 |
| | 363 | 33.14 | 100% | 508.2 |

TABLE 6
Strawberry Formulation

| | Weight | Dry | % Dry | Actual |
|---|---|---|---|---|
| Strawberry | (g) | Weight | Weight | Weight |
| Frozen | 180 | 16.74 | 59.5% | 206.6677 |
| Strawberry | | | | |
| Yogurt | 18 | 2.7 | 9.6% | 20.66677 |
| Water (for | 90 | | | 103.3339 |
| Puree) | | | | |
| Water (for | 60 | | | 68.88923 |
| gelatin) | | | | |
| Gelatine | 10 | 8.7 | 30.9% | 11.48154 |
| | | 28.14 | 100.0% | |

TABLE 7
Blend of Hydrocolloids Formulation

| | Wet | | Dry |
|---|---|---|---|
| | Weight | | Weight |
| | (g) | % Formula | (g) |
| Tomato Puree | 34.45 | 57.85% | 3.45 |
| Ranch Powder | 3.5 | 5.88% | 3.15 |
| Parmazan Cheese | 8 | 13.43% | 7.60 |
| Blend of pea protein | 13.6 | 22.84% | 12.92 |
| powder and agar | | | |
| | 59.55 | | 27.12 |

### Example 8

### Viscosities of Various Food Purees of the Present Invention

Provided below are viscosities of various purees of the present invention. These viscosities are illustrative and are not meant to be limiting on the present invention.

TABLE 8
Product Viscosities Measured with Brookfield Helipath on RV Viscometer at 10 RMP

| | | | % of | Viscosity |
|---|---|---|---|---|
| Product | Spindle | Coefficient | Scale | (cP) |
| Carrot Puree | T-F | 10,000 | 13.1 | 131250 |
| Carrot Puree | T-E | 5,000 | 31.3 | 156667 |
| Carrot pre aeration | T-E | 5,000 | 22.4 | 112000 |
| Carrot Foam | T-E | 5,000 | 4.0 | 20000 |
| Carrot Set (20 min after | T-E | 5,000 | 29.5 | 147500 |
| aeration) | | | | |
| Carrot Cold 4° C. overnight | T-F | 10,000 | 70.0 | 700000 |
| Broccoli Puree | T-E | 5,000 | 21.8 | 109000 |
| Broccoli Pre aeration | T-E | 5,000 | 18.6 | 93182 |
| Broccoli Foam | T-E | 5,000 | 4.0 | 20000 |
| Broccoli Set (20 min after | T-E | 5,000 | 22.3 | 111429 |
| aeration) | | | | |
| Broccoli Cold 4° C. overnight | T-F | 10,000 | 69.8 | 697500 |
| Tomato Puree | T-E | 5,000 | 3.3 | 16591 |
| Tomato pre aeration | T-E | 5,000 | 2.0 | 10000 |
| Tomato Aerated | T-E | 5,000 | 1.1 | 5417 |
| Tomato Set (1 hour after | T-E | 5,000 | 63.0 | 315000 |
| aeration) | | | | |
| Tomato Cold 4° C. overnight | T-F | 10,000 | 76.3 | 762500 |

### Example 9

### Hardness of Various Food Products of the Present Invention

Provided below are hardness values of various food products of the present invention. These hardness values are illustrative and are not meant to be limiting on the present invention.

TABLE 9
Hardness (N)

| | | | |
|---|---|---|---|
| Broccoli | Rep 1 | 87.755 | 123.836 |
| | Rep 2 | 161.43 | |
| | Rep 3 | 122.323 | |
| Strawberry | Rep 1 | 122.011 | |
| Control-whole carrot | Rep 1 | 245.181 | |
| piece | | | |

Test conditions: Compression test, 0.75 mm cylindrical head, 90% compression, about 2 mm×2 mm surface area for each sample; spd 2 mm/s.

### Example 10

### Water Activity of Various Food Products of the Present Invention

Provided below are water activity values of various food products of the present invention. These water activity values are illustrative and are not meant to be limiting on the present invention.

TABLE 10
Moisture and Water Activity (Aw)

| | | Water activity |
|---|---|---|
| MC Sample | | (Aw) |
| Carrot | 11.02% | — |
| | 13.99% | |
| Tomato | 7.36% | 0.205 |
| Broccoli | 9.24% | 0.136 |
| Strawberry | 9.64% | 0.195 |
| Control-whole carrot | 6.63% | 0.221 |
| piece | | |

### REFERENCES

Citation of a reference herein shall not be construed as an admission that such reference is prior art to the present invention. The following references, to the extent that they provide exemplary procedural or other details supplementary to those set forth herein, are specifically incorporated herein by reference:
1. The Packer. Fresh Trends 2010. Cited: Jan. 24, 2011. www.thepacker.com.
2. Fruits and Veggies Matter. Fruits and Veggies Matter. Cited: Jan. 22, 2011. www.fruitsandveggiesmatter.gov.
3. Food and Drug Administration. Code of Federal Regulations Title 21. Code of Federal Regulations. Cited: Apr. 17, 2011. www.accessdata.fda.gov/scripts/cdrh/cfdocs/cfcfr/CFRSearch.cfm?fr=101.12.
4. Food and Drug Administration. Food Labeling Guide 14 Appendix F Calculate the Percent Daily Value for the Appropriate Nutrients. Guidance For Industry: A Food Labeling Guide. Mar. 14, 2011. Cited: Apr. 17, 2011. www.fda.gov/Food/GuidanceComplianceRegulatoryInformation/GuidanceDocuments/FoodLabelingNutrition/FoodLabelingGuide/ucm064928.htm.
5. Mars Incorporated. What's A GDA. Mars Living Healthy. Cited: Apr. 17, 2011. marshealthyliving.com/whats-gda.
6. E.T. Oakes Corporation. Hydrolic Slurry Mixers. E.T. Oakes Corporation. E.T. Oakes Corporation. Cited: Apr. 18, 2011. www.oakes.com/.
7. Gould, Wilbur A. Unit Operations for the Food Industries. Timonium, Md.: CTI Publications, 1996.
8. MillRock Technology Inc. Freeze Dryers (Lyophilizers) Quanta Series. Kingston, N.Y.: MillRock Technology, 2008.
9. Labuza, T. P. and Katz, E. E. Effect of Water Activity on the Sensory Crispness and Mechanical Deformation of Snack Food Products. J. Food Science, 1981, Vol. 46.
10. Oregon Freeze Dry Inc. Mountain House Freeze Dried Food, Shelf Life, Pouches. Cited:
Apr. 19, 2011. www.mountainhouse.com/shelf_lif.cfm.
11. Salty Snacks-US-August 2009. s.l.: Mintel, 2009.
12. Food and Drug Administration. My Pyramid. Cited: Jan. 22, 2011. www.mypyramid.gov.
13. Mintel GNPD. Top Ten Flavors in New Salad Dressing Launches October 2009-October 2010. Mintel Inc., 2010.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A dehydrated and aerated food product comprising:
a plant puree mixture and a hydrocolloid,
wherein said plant puree mixture and said hydrocolloid combine to form a dehydrated and aerated plant puree foam having a hydrocolloid-based aeration network dispersed throughout the plant puree mixture.

2. The food product according to claim 1, wherein the plant puree mixture comprises a vegetable puree, a fruit puree, or a mixture thereof.

3. The food product according to claim 1, wherein the plant puree mixture is present in an amount ranging from about 10 percent by weight to about 95 percent by weight based on total dry weight.

4. The food product according to claim 1, wherein the hydrocolloid is selected from the group consisting of gelatin, pectin, carrageenan, alginate, starch, gum, modified starch, albumin (egg whites), agar, pea protein, whipped cream, and mixtures thereof.

5. The food product according to claim 1, wherein the hydrocolloid is present in an amount ranging from about 1 percent by weight to about 35 percent by weight based on total dry weight.

6. The food product according to claim 1, wherein the food product has a density ranging from about 0.05 g/cc to about 0.2 g/cc.

7. The food product according to claim 1, wherein the food product has a moisture content ranging from about 0.05 percent to about 30 percent by weight based on total dry weight.

8. The food product according to claim 1, wherein the food product has a water activity ranging from about 0.05 to about 0.5.

9. The food product according to claim 1, wherein the food product has an overrun of between about 2 percent and about 80 percent.

10. The food product according to claim 1, wherein the food product has a hardness value ranging from about 50 Newtons to about 180 Newtons.

11. The food product according to claim 1, wherein the combination of the plant puree mixture and the hydrocolloid prior to dehydration has a viscosity ranging from about 1,000 to about 700,000 centipoise (cP).

12. The food product according to claim 1, wherein the hydrocolloid network is thermally reversible.

13. The food product according to claim 1, wherein the plant puree mixture substantially retains its natural color prior to being combined with the hydrocolloid to form the dehydrated and aerated plant puree foam.

14. The food product according to claim 1, wherein the plant puree mixture substantially retains its nutritive qualities prior to being combined with the hydrocolloid to form the dehydrated and aerated plant puree foam.

15. The food product according to claim 14, wherein the nutritive qualities comprise one or more nutritive quality selected from the group consisting of antioxidants, vitamins, polyphenols, tannins, anthocyanins, flavonoids, hydroxycinnamic acids, catechins, procyanidins, tocopherols, and carotenoids.

16. The food product according to claim 1, wherein the food product further comprises:
at least one food additive selected from the group consisting of a flavoring component, a coloring component, a nutritive additive, a nutritive sweetener, a non-nutritive sweetener, a seasoning component, yogurt, a spice component, a functional ingredient, protein additive, a dairy ingredient, and mixtures thereof.

17. The food product according to claim 1, wherein the plant puree mixture and hydrocolloid combination are not subject to heat-based dehydration when combined to form the dehydrated and aerated plant puree foam.

18. A method of making a plant puree food product, said method comprising the steps of:
combining a plant puree mixture with a hydrocolloid under conditions effective to disperse the hydrocolloid throughout the plant puree mixture;
aerating the plant puree mixture/hydrocolloid combination under conditions effective to yield a stable aerated plant puree foam; and
dehydrating the aerated plant puree foam using a non-heat-based dehydration process to yield the plant puree food product,
wherein said plant puree food product comprises a dehydrated and aerated plant puree foam having a hydrocolloid-based aeration network dispersed throughout the plant puree mixture.

19. The method according to claim 18 further comprising:
prior to the dehydrating step, forming the aerated plant puree foam into a desired shape, thereby yielding a plant puree food product having said desired shape.

20. The method according to claim 18, wherein said non-heat-based dehydration process comprises freeze-drying, vacuum-drying, or any other assisted freeze-drying method.

21. The method according to claim 20, wherein the step of dehydrating comprises freeze-drying the aerated plant puree foam in a freeze-dryer having a condenser, said freeze-drying comprising:
cooling the aerated plant puree foam to a temperature of between about −60 degrees Celsius and about 0 degrees Celsius at a pressure from about 10 Pascal (Pa) to about 98,000 Pa;
adjusting the temperature by gradually increasing the temperature inside the freeze-dryer to between about 15 degrees Celsius and about 30 degrees Celsius while maintaining the temperature of the condenser at between about −70 degrees Celsius and about −10 degrees Celsius; and
incubating the aerated plant puree foam in the freeze-dryer until the internal temperature of the aerated plant puree foam is substantially equal to ambient temperature.

22. The method according to claim 21, wherein the step of adjusting the temperature comprises increasing the temperature inside the freeze-dryer to about 24 degrees Celsius while maintaining the temperature of the condenser at about −60 degrees Celsius.

23. The method according to claim 18, wherein the plant puree mixture comprises a vegetable puree, a fruit puree, or a mixture thereof.

24. The method according to claim 18, wherein the plant puree mixture is provided as an aseptic puree mixture.

25. The method according to claim 18, wherein the hydrocolloid is selected from the group consisting of gelatin, pectin, carrageenan, alginate, starch, gum, agar, pea protein, whipped cream, and mixtures thereof.

26. The method according to claim 18, wherein the combining, aerating, and dehydrating steps are performed so that the plant puree mixture substantially retains its natural color as it has prior to being subjected to the combining, aerating, and dehydrating steps.

27. The method according to claim 18, wherein the combining, aerating, and dehydrating steps are performed so that the plant puree mixture substantially retains its nutritive qualities as it has prior to being subjected to the combining, aerating, and dehydrating steps.

28. The method according to claim 27, wherein the nutritive qualities comprise one or more nutritive quality selected from the group consisting of antioxidants, vitamins, polyphenols, tannins, anthocyanins, flavonoids, hydroxycinnamic acids, catechins, procyanidins, tocopherols, and carotenoids.

29. The method according to claim 18 further comprising:
prior to said aerating step, adding at least one food additive selected from the group consisting of a flavoring component, a coloring component, a nutritive additive, a nutritive sweetener, a non-nutritive sweetener, a seasoning component, a spice component, a functional ingredient, protein additive, a fat, an oil, a dairy ingredient, and mixtures thereof.

30. The method according to claim 18, wherein prior to said combining step the plant puree mixture and hydrocolloid are separately subjected to a sterilization procedure.

31. The method according to claim 30, where said sterilization procedure comprises heat treatment.

32. A plant puree food product produced according to the method of claim 18.

33. A combination food product comprising:
a dehydrated and aerated food product according to claim 1 combined with another edible foodstuff.

34. The combination food product according to claim 33, wherein said combination food product is in the form selected from the group consisting of a bar, trail mix, drink mix, cereal, dry soup mix, noodle mix, and dietary supplement.

35. The combination food product according to claim 33, wherein said dehydrated and aerated food product is provided in a sealed container.

36. The combination food product according to claim 35, wherein said sealed container is configured as a bowl, bowl-like structure, bag, or bottle for combining the dehydrated and aerated food product with a liquid in order to reconstitute the dehydrated and aerated food product into a liquid puree.
